(19) United States
(12) Patent Application Publication
(10) Pub. No.: US 2007/0299821 A1
(43) Pub. Date: Dec. 27, 2007

(54) Report specification system and method

(76) Inventors: Eric McCully, Gloucester (CA); Soufiane Azizi, Ottawa (CA); Charles Michael Potter, Greely (CA); Stephen Gibson, Kemptville (CA)

Correspondence Address: PEARNE & GORDON LLP, 1801 EAST 9TH STREET, SUITE 1200, CLEVELAND, OH, 44114-3108, US

(21) Appl. No.: 11/473,657

(22) Filed: Jun. 23, 2006

(51) Int. Cl. G06F 17/30

(52) U.S. Cl. 707/3

(57) ABSTRACT

A report specification for defining a report and a system and method of producing a report output from a report definition are provided. The report specification comprises a data selection specification for defining one or more sets of data that are to be reported against and a layout specification for defining how the data is to be structured and rendered. The layout specification including elements that are typically defined in a query. The system comprises a report engine for decomposing a report definition into a layout definition and a query set component, a query engine for processing a query results definition of the query set to produce query results to be rendered, and a rendering engine for creating the final report by using the query results and the layout definition. The method comprises the steps of decomposing a report definition into a layout definition and a query set component, processing a query results definition of the query set to produce query results to be rendered, and creating the final report by using the query results and the layout definition.

### FIELD OF INVENTION

The present invention relates to a system and method of report specification.

### BACKGROUND OF THE INVENTION

Central to a reporting system is the definition of a report. There are many different ways to specify a report. A report may be banded, frame-based, based upon a layout model or generated from code.

There are many different approaches to defining a report. The current approaches of report specification suffer from various problems. Current report specifications unnecessarily replicate information contained in metadata models, which make the report specifications overly complex and cause the report specifications to not properly leverage the underlying metadata.

Current report specifications often do not accurately reflect the information that has been provided by the report author. Such report specifications can contains more information than was provided by the report author, whereby this extra information was inserted by the authoring tool which has applied its own “business intelligence” to deduce the author's intent. Often, such report specifications contain some ambiguities, are typically unreadable, and the report model does not match concepts exposed in a report authoring tool.

There is a need for a better way of defining and running reports.

### SUMMARY OF THE INVENTION

This invention sets out to address and/or minimize many of the problems described above. The present invention attempts to capture only the information that the author would provide. The “business intelligence” is then applied to consume the specification in order to produce the report output as opposed to using the “business intelligence” to produce the specification.

In accordance with an embodiment of the present invention, there is provided a report specification for defining a report. The report specification comprises a data selection specification for defining one or more sets of data that are to be reported against and a layout specification for defining how the data is to be structured and rendered. The layout specification including elements that are typically defined in a query.

In accordance with another embodiment of the present invention, there is provided a method of producing a report output from a report definition. The method comprises the steps of decomposing a report definition into a layout definition and a query set component, processing a query results definition of the query set to produce query results to be rendered, and creating the final report by using the query results and the layout definition.

In accordance with another embodiment of the present invention, there is provided a system for producing a report output from a report definition. The system comprises a report engine for decomposing a report definition into a layout definition and a query set component, a query engine for processing a query results definition of the query set to produce query results to be rendered, and a rendering engine for creating the final report by using the query results and the layout definition.

In accordance with another embodiment of the present invention, there is provided a memory containing computer executable instructions that can be read and executed by a computer for caring out a method of producing a report output from a report definition. The method comprises the steps of decomposing a report definition into a layout definition and a query set component, processing a query results definition of the query set to produce query results to be rendered and creating the final report by using the query results and the layout definition.

In accordance with another embodiment of the present invention, there is provided a carrier carrying a propagated signal containing computer executable instructions that can be read and executed by a computer. The computer executable instructions are used to execute a method of producing a report output from a report definition. The method comprises the steps of decomposing a report definition into a layout definition and a query set component, processing a query results definition of the query set to produce query results to be rendered and creating the final report by using the query results and the layout definition.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows in a component diagram an example of a report specification, in accordance with an embodiment of the present invention;

FIG. 2 shows in a component diagram a more detailed example of the report specification;

FIG. 3 shows in a process flow diagram an example of a process used to take a report definition and produce a report output, in accordance with an embodiment of the report specification; and

FIG. 4 shows in a screenshot an example of a report output combining a crosstab and a chart, in accordance with an embodiment of the report specification.

### DETAILED DESCRIPTION

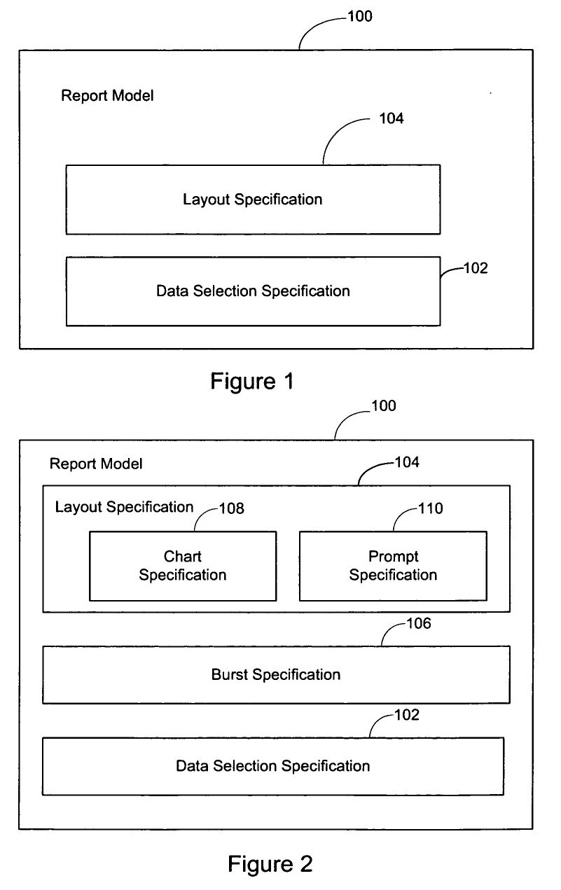

FIG. 1 shows in a component diagram an example of a report model (or report specification) 100, in accordance with an embodiment of the present invention. The report model 100 is used to define a report. This includes the definition of what data is being reported against and how that data is to be rendered. The report model 100 comprises a data selection (sometimes referred to as “query”) specification 102 for defining one or more sets of data that are to be reported against, and a layout specification 104 for defining how the data is to be structured and rendered (including elements that are typically defined in a query, i.e., grouping, sorting, properties).

FIG. 2 shows in a component diagram a more detailed example of the report model (or report specification) 100, in accordance with an embodiment of the present invention. The report model 100 is used to define a report. This includes the definition of what data is being reported against and how that data is to be rendered. The report model 100 comprises a data selection (sometimes referred to as “query”) specification 102 for defining one or more sets of data that are to be reported against, a layout specification 104 for defining how the data is to be structured and rendered (including elements that are typically defined in a query, i.e., grouping, sorting, properties), and a burst specification 106 for defining how the report is to be segmented and delivered to various recipients. The layout specification 104 includes a chart specification 108 for defining how the data is to be structure and rendered in a chart form and a prompt specification 110 for defining how to prompt for parameters that can be used in the definition of the query. The data selection specification 102 references an underlying metadata model which can be relational or multidimensional.

Elements that are traditionally considered part of a query specification are present in the layout specification 104 (e.g., sorting, grouping, properties). Advantageously, this avoids having redundant specification in both the layout 104 and query portions of the specification, and provides the server that must render the described reports the flexibility to choose the optimal query that can be executed to render the requested data as desired.

The data selection specification 102 allows for the specification of the data desired in a manner that leverages but does not replicate the information contained in the underlying model. Advantageously, this approach provides for a high level specification that is capable of complex data request.

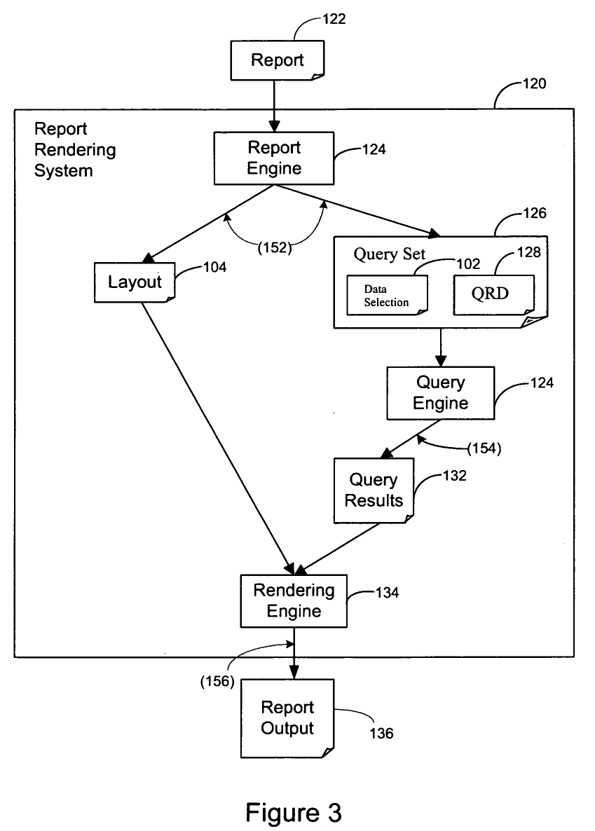

FIG. 3 shows in a process flow diagram an example of a process used by a report rendering system 120 to take a report definition and produce a report output (150), in accordance with an embodiment of the report specification. The report engine 124 takes a report definition 122 and decomposes it into two pieces (152): the layout 104 and a query set 126. The query set 126 comprises queries from the report 122 and query results definitions (QRD) 128. A QRD 128 is a topological description of the visual structure in which the data will be rendered and is used by the report engine 124 to describe how the data should be structured so that it can render the data appropriately. The QRD is produced by examining the layout specification 104 and determining a data structure that is optimal to product the desired layout. The QRD 128 is then processed by the query engine 130 to produce the query results (i.e., data) 132 that is to be rendered (154). The rendering engine 134 takes the query results 132 and then using the layout definition 104 creates the final report output 136 (156).

Traditionally, this “business intelligence” has been locked up in the report authoring tools thereby requiring the tools in order to build reports. Since the specification only captures what the author has provided, only the server that consumes this specification can now apply the business intelligence. Therefore, this business intelligence is pushed down into the servers so that anyone building a report specification 100 either through the provided authoring tools or by manually building the report specification can take advantage of a high level specification. The layout specification 102 is designed to define how the data is to be “structured” and “rendered”, not how to obtain the data. In other words, the “intent” of the report is captured.

The charting specification 108 allows for a level of flexibility in choosing how data is charted. The reporting model 100 allows authors to place aggregates and measures in multiple locations in the charting specification 108. For example, not only can revenue be placed in the pie slices of a chart, it can also be placed in the chart title or legend. By virtue of the report specification 100 defined in the present invention, the server is able to formulate an advanced query that provides the results the author is expecting.

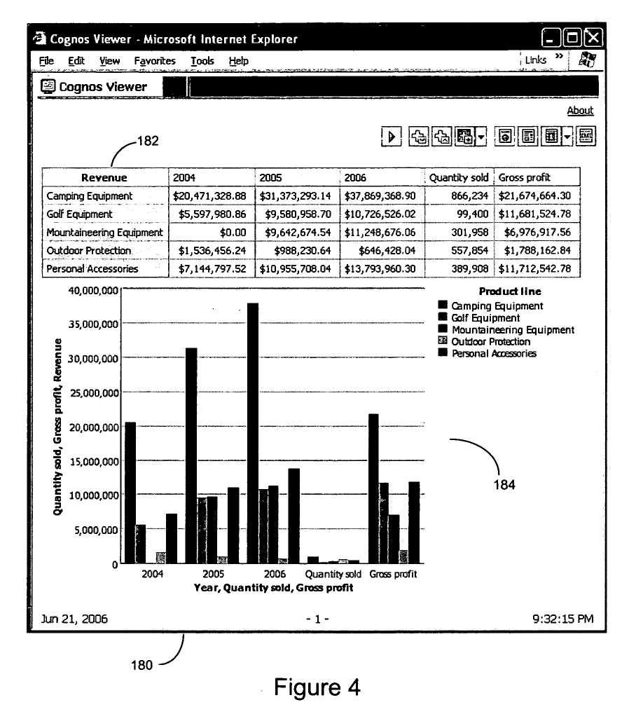

Another example of this relationship between layout and query in charts is the concept of union. Normally it would be impossible or very difficult to show a chart that shows revenue for products and regions (unrelated data) on the same axis. In this reporting model 100, the author simply has to place references to products and regions beside each other and the server will formulate the correct query. This is in essence showing data from two charts in one. FIG. 4 shows in a screenshot an example of a report output 180 combining a crosstab 182 and a chart 184, in accordance with an embodiment of the report specification 100.

The charting specification 108 also facilitates simple authoring of charts. Rather than having to understand the distinction of categories and series, the author can specify the chart layout in simple English terms. For example, the author specifies which data will be represented by individual pies and which data will be represented by individual pie slices in a pie chart. Advantageously, this is very clear to the author. The server takes this simple layout specification and formulates the correct query and rendering to provide the author the desired chart.

Advantageously, the report model specification 100 does not replicate information that is available in the underlying metadata model, thereby fully leveraging it. The report model specification 100 captures only the information that was provided by the report author and provides a conceptual model for a report that can be used as the concepts exposed in a report authoring tool. Advantageously, the report model specification 100 also requires/allows for the applying of “business intelligence” in the consumption of the report specification as opposed to requiring it for the producing of the report specification.

The following is an example of a report specification 122 that is sed to generate the output 180 shown in FIG. 4:

```
- <report xmlns=“http://developer.cognos.com/schemas/report/2.0/”
    expressionLocale=“en”>
  - <!--
  RS:8.1
    -->
    <modelPath>/content/package[@name=‘Great Outdoors
      Company’]/model[@name=‘model’]</modelPath>
  - <queries>
    - <query name=“Query1”>
      - <source>
          <model />
        </source>
      - <selection>
        - <dataItem name=“Product line” aggregate=“none”>
            <expression>[great_outdoors_company].[Products].[Products].[Product line]</expression>
          </dataItem>
      - <dataItem name=“Year” aggregate=“none”>
            <expression>[great_outdoors_company].[Years].[Years].[Year]</expression>
        </dataItem>
      - <dataItem name=“Revenue”>
            <expression>[great_outdoors_company].[Measures].[Revenue]</expression>
        </dataItem>
      - <dataItem name=“Quantity sold”>
            <expression>[great_outdoors_company].[Measures].[Quantity sold]</expression>
        </dataItem>
      - <dataItem name=“Gross profit”>
            <expression>[great_outdoors_company].[Measures].[Gross profit]</expression>
        </dataItem>
      </selection>
    </query>
  </queries>
- <layouts>
  - <layout>
    - <reportPages>
      - <page class=“pg” name=“Page1”>
        - <pageBody class=“pb”>
          - <contents>
            - <crosstab class=“xt” refQuery=“Query1”>
              - <crosstabCorner class=“xm”>
                - <contents>
                  - <textItem>
                    - <dataSource>
                      <dataItemLabel
                        refDataItem=“Revenue” />
                    </dataSource>
                  </textItem>
                </contents>
              </crosstabCorner>
            - <style>
                <CSS value=“border-collapse:collapse” />
              </style>
            - <crosstabRows>
              - <crosstabNode>
                - <crosstabNodeMembers>
                  - <crosstabNodeMember refDataItem=“Productline” class=“ml”>
                    - <contents>
                      - <textItem>
                        - <dataSource>
                            <memberCaption />
                          </dataSource>
                        </textItem>
                      </contents>
                    </crosstabNodeMember>
                  </crosstabNodeMembers>
                </crosstabNode>
              </crosstabRows>
            - <crosstabColumns>
              - <crosstabNode>
                - <crosstabNodeMembers>
                  - <crosstabNodeMember refDataItem=“Year”
                      class=“ml”>
                    - <contents>
                      - <textItem>
                        - <dataSource>
                            <memberCaption />
                          </dataSource>
                        </textItem>
                      </contents>
                    </crosstabNodeMember>
                  </crosstabNodeMembers>
                </crosstabNode>
              - <crosstabNode>
                - <crosstabNodeMembers>
                  - <crosstabNodeMember refDataItem=“Quantity sold”
                      class=“ml”>
                    - <contents>
                      - <textItem>
                        - <dataSource>
                            <memberCaption />
                          </dataSource>
                        </textItem>
                      </contents>
                    </crosstabNodeMember>
                  </crosstabNodeMembers>
                </crosstabNode>
              - <crosstabNode>
                - <crosstabNodeMembers>
                  - <crosstabNodeMember refDataItem=“Gross profit”
                      class=“ml”>
                    - <contents>
                      - <textItem>
                        - <dataSource>
                            <memberCaption />
                          </dataSource>
                        </textItem>
                      </contents>
                    </crosstabNodeMember>
                  </crosstabNodeMembers>
                </crosstabNode>
                    </crosstabColumns>
                    <defaultMeasure refDataItem=“Revenue” />
                  - <crosstabFactCell class=“mv”>
                    - <contents>
                      - <textItem>
                        - <dataSource>
                            <cellValue />
                          </dataSource>
                        </textItem>
                      </contents>
                    </crosstabFactCell>
                  </crosstab>
                - <combinationChart depth=“0” orientation=“vertical” class=“ch”
                    refQuery=“Query1”>
                  - <legend class=“lg”>
                    - <legendPosition>
                        <relativeposition />
                      </legendPosition>
                      <legendTitle class=“lx” />
                    </legend>
                  - <ordinalAxis class=“al”>
                      <axisTitle class=“at” />
                      <axisLine color=“black” />
                    </ordinalAxis>
                  - <numericalAxisY1 class=“al”>
                      <axisTitle class=“at” />
                      <gridlines color=“#cccccc” />
                      <axisLine color=“black” />
                    </numericalAxisY1>
                  - <combinationChartTypes>
                    - <bar>
                      - <chartNodes>
                        - <chartNode>
                          - <chartNodeMembers>
                            - <chartNodeMember refDataItem=“Product line”>
                              - <chartContents>
                                - <chartTextItem>
                                  - <dataSource>
                                  <memberCaption/>
                            </dataSource>
                          </chartTextItem>
                        </chartContents>
                      </chartNodeMember>
                    </chartNodeMembers>
                  </chartNode>
                </chartNodes>
              <bar>
            </combanationChartTypes>
          - <style>
              <CSS value=“padding:5px;width:600px” />
            </style>
          <defaultChartMeasure refDataItem=“Revenue” />
          - <commonClusters>
            - <chartNodes>
              - <chartNode>
                - <chartNodeMembers>
                  - <chartNodeMember refDataItem=“Year”>
                    - <chartContents>
                      - <chartTextItem>
                        - <dataSource>
                                  <memberCaption/>
                          </dataSource>
                        </chartTextItem>
                      </chartContents>
                    </chartNodeMember>
                  </chartNodeMembers>
                </chartNode>
              - <chartNode>
                - <chartNodeMembers>
                  - <chartNodeMember refDataItem=“Quantity sold”>
                    - <chartContents>
                      - <chartTextItem>
                        - <dataSource>
                                  <memberCaption/>
                          </dataSource>
                        </chartTextItem>
                      </chartContents>
                    </chartNodeMember>
                  </chartNodeMembers>
                </chartNode>
              - <chartNode>
                - <chartNodeMembers>
                  - <chartNodeMember refDataItem=“Gross profit”>
                  - <chartContents>
                    - <chartTextItem>
                      - <dataSource><memberCaption/>
                                    </dataSource>
                                  </chartTextItem>
                                </chartContents>
                              </chartNodeMember>
                            </chartNodeMembers>
                          </chartNode>
                        </chartNodes>
                      </commonClusters>
                    </combinationChart>
                  </contents>
                </pageBody>
              - <pageHeader class=“ph”>
                - <contents>
                  - <block class=“ta”>
                    - <contents>
                      - <textItem class=“tt”>
                        - <dataSource>
                            <staticValue />
                          </dataSource>
                        </textItem>
                      </contents>
                    </block>
                  </contents>
                - <style>
                    <CSS value=“padding-bottom:10px” />
                  </style>
                </pageHeader>
              - <pageFooter class=“pf”>
                - <contents>
                  - <table class=“tb”>
                    - <tableRows>
                      - <tableRow>
                        - <tableCells>
                          - <tableCell>
                            - <contents>
                              - <textItem>
                        - <dataSource>
                              <reportExpression>AsOfDate( )</reportExpression
                          >
                        </dataSource>
                      </textItem>
                    </contents>
                        - <style>
<CSS value=“vertical-align:top;text-
                          align:left;width:25%” />
                      </style>
                    </tableCell>
                  - <tableCell>
                    - <contents>
                      - <textItem>
                      - <dataSource>
                            <staticValue>-</staticValue>
                          </dataSource>
                        </textItem>
                      - <textItem>
                        - <dataSource>
                              <reportExpression>PageNumber( )</report
                              Expression>
                          </dataSource>
                        </textItem>
                      - <textItem>
                        - <dataSource>
                            <staticValue>-</staticValue>
                          </dataSource>
                        </textItem>
                      </contents>
                    - <style>
                        <CSS value=“vertical-align:top;text-
                          align:center;width:50%” />
                      </style>
                    </tableCell>
                - <tableCell>
                    - <contents>
                      - <textItem>
                        - <dataSource>
                            <reportExpression>AsOfTime( )</reportExpression>
                          </dataSource>
                        </textItem>
                      </contents>
                    - <style>
                        <CSS value=“vertical-align:top;text-
                          align:right;width:25%” />
                      </style>
                    </tableCell>
                    </tableCells>
                  </tableRow>
                </tableRows>
              - <style>
                  <CSS value=“border-collapse:collapse;width:100%” />
                </style>
              </table>
            </contents>
          - <style>
              <CSS value=“padding-top:10px” />
            </style>
          </pageFooter>
        </page>
      </reportPages>
    </layout>
  </layouts>
</report>
```

The following is an example of a report model definition 100:

```
<?xml version=“1.0” encoding=“UTF-8”?>
<!--
  Copyright (C) 2006 Cognos Incorporated. All Rights Reserved.
  Cognos (R) is a trademark of Cognos Incorporated.
-->
<xs:schema xmlns=“http://developer.cognos.com/schemas/report/2.0/”
xmlns:xs=“http://www.w3.org/2001/XMLSchema”
targetNamespace=“http://developer.cognos.com/schemas/report/2.0/”
elementFormDefault=“qualified” attributeFormDefault=“unqualified”>
  <xs:include schemaLocation=“V5_base.xsd”/>
  <xs:include schemaLocation=“V5_layoutbase.xsd”/>
  <xs:include schemaLocation=“V5_format.xsd”/>
  <xs:include schemaLocation=“V5_style.xsd”/>
  <xs:include schemaLocation=“V5_prompt.xsd”/>
  <xs:include schemaLocation=“V5_chart.xsd”/>
  <xs:include schemaLocation=“V5_layout.xsd”/>
  <xs:include schemaLocation=“V5Query.xsd”/>
  <xs:element name=“report”>
      <xs:annotation>
        <xs:documentation>This element contains the entire
report specification. The expressionLocale attribute indicates the
locale of all report and query expressions in the report.
</xs:documentation>
      </xs:annotation>
      <xs:complexType>
        <xs:all>
          <xs:element ref=“modelPath” minOccurs=“0”/>
          <xs:element ref=“layouts”/>
          <xs:element name=“queries” minOccurs=“0”>
            <xs:complexType>
              <xs:sequence maxOccurs=“unbounded”>
                <xs:element ref=“query”/>
              </xs:sequence>
            </xs:complexType>
          </xs:element>
          <xs:element ref=“classStyles” minOccurs=“0”/>
          <xs:element ref=“burst” minOccurs=“0”/>
          <xs:element  ref=“reportVariables”
minOccurs=“0”/>
          <xs:element  ref=“drillBehavior”
minOccurs=“0”/>
          <xs:element  ref=“XMLAttributes”
minOccurs=“0”/>
          <xs:element name=“upgradeInfo” minOccurs=“0”>
            <xs:complexType>
              <xs:all>
                <xs:element
name=“upgradedSpec” minOccurs=“0”>
                  <xs:simpleType>
                    <xs:restriction
base=“xs:string”>
                      <xs:whiteSpace
value=“preserve”/>
                    </xs:restriction>
                  </xs:simpleType>
                </xs:element>
                <xs:element
name=“upgradeMessages” minOccurs=“0”>
                  <xs:complexType>
                    <xs:sequence>
                      <xs:element
name=“upgradeMessage” maxOccurs=“unbounded”>
  <xs:complexType>
  <xs:simpleContent>
  <xs:extension base=“xs:string”>
      <xs:attribute name=“type” use=“required”>
        <xs:annotation>
            <xs:documentation
source=“doc_att_type_upgradeMessage”/>
        </xs:annotation>
        <xs:simpleType>
          <xs:restriction base=“xs:string”>
            <xs:enumeration value=“error”/>
            <xs:enumeration value=“warning”/>
            <xs:enumeration value=“info”/>
          </xs:restriction>
        </xs:simpleType>
      </xs:attribute>
    </xs:extension>
    </xs:simpleContent>
    </xs:complexType>
                      </xs:element>
                    </xs:sequence>
                  </xs:complexType>
                </xs:element>
              </xs:all>
            </xs:complexType>
          </xs:element>
        </xs:all>
      <xs:attribute name=“expressionLocale”
type=“xs:language” use=“required”/>
        <xs:attribute name=“template” type=“xs:boolean”
default=“false”/>
        <xs:attribute name=“useStyleVersion”>
          <xs:simpleType>
            <xs:restriction base=“xs:string”>
              <xs:enumeration value=“1”/>
            </xs:restriction>
          </xs:simpleType>
        </xs:attribute>
      </xs:complexType>
    </xs:element>
</xs:schema>
```

The following is an example of a query set definition 126:

```
<?xml version=“1.0” encoding=“UTF-8”?>
<!--
  Copyright (C) 2006 Cognos Incorporated. All Rights Reserved.
  Cognos (R) is a trademark of Cognos Incorporated.
-->
<xs:schema  elementFormDefault=“qualified”
attributeFormDefault=“unqualified”
xmlns:xs=“http://www.w3.org/2001/XMLSchema”>
    <xs:include schemaLocation=“V5Query.xsd”/>
    <xs:include schemaLocation=“V5QueryResultDefinition.xsd”/>
    <xs:element name=“querySet”>
      <xs:annotation>
        <xs:documentation>Root Element of the V5 query
specification. The Query Framework (i.e. the Bering Common Query
Engine) expects a valid querySet per request. A querySet has one or
more  named  queries  and  one  or  more  named
queryResultDefinitions(QRDs).  Each QRD is based on a single query
and must reference it.  Multiple QRDs in the same querySet can
reference the same query.  A QSAPI Masterdataset is returned for
each  queryResultDefinition  specified  in  a
querySet.</xs:documentation>
      </xs:annotation>
      <xs:complexType>
        <xs:complexContent>
          <xs:extension base=“querySetType”>
            <xs:attribute  name=“expressionLocale”
type=“xs:language” use=“required”>
              <xs:annotation>
                <xs:documentation>The
expressionLocale  attribute  indicates  the  locale  of  all
query expressions in the request. It is required.</xs:documentation>
              </xs:annotation>
            </xs:attribute>
          </xs:extension>
        </xs:complexContent>
      </xs:complexType>
    </xs:element>
    <!--Types: -->
    <xs:complexType name=“queriesType”>
      <xs:choice maxOccurs=“unbounded”>
        <xs:element ref=“query”/>
      </xs:choice>
    </xs:complexType>
    <xs:complexType name=“queryResultDefinitionsType”>
      <xs:sequence>
        <xs:element  ref=“queryResultDefinition”
maxOccurs=“unbounded”/>
      </xs:sequence>
    </xs:complexType>
    <xs:complexType name=“querySetType”>
      <xs:all>
        <xs:element ref=“modelPath” minOccurs=“0”/>
        <xs:element name=“queries” type=“queriesType”>
          <xs:annotation>
            <xs:documentation>a  set  of  queries
</xs:documentation>
          </xs:annotation>
        </xs:element>
        <xs:element  name=“queryResultDefinitions”
type=“queryResultDefinitionsType”>
          <xs:annotation>
            <xs:documentation>a set of
QRDs</xs:documentation>
          </xs:annotation>
        </xs:element>
        <xs:element  name=“requestHints”
type=“requestHintsType” minOccurs=“0”>
          <xs:annotation>
            <xs:documentation>hints that apply to all
queries in this querySet</xs:documentation>
          </xs:annotation>
        </xs:element>
      </xs:all>
  </xs:complexType>
  <xs:complexType name=“requestHintsType”>
    <xs:all>
      <xs:element name=“noDataMode” minOccurs=“0”>
        <xs:annotation>
          <xs:documentation>When enabled, query
returns sample (fake) data for this request.</xs:documentation>
        </xs:annotation>
        <xs:complexType>
          <xs:attribute  name=“enabled”
type=“xs:boolean” default=“true”/>
        </xs:complexType>
      </xs:element>
      <xs:element name=“designMode” minOccurs=“0”>
        <xs:annotation>
          <xs:documentation>When enabled, Query
Framework applies all design filters that are specified in the model
for the query subjects  associated  with  this
request.</xs:documentation>
        </xs:annotation>
        <xs:complexType>
          <xs:attribute  name=“enabled”
type=“xs:boolean” default=“true”/>
        </xs:complexType>
      </xs:element>
      <xs:element  ref=“executionOptimization”
minOccurs=“0”/>
      <xs:element ref=“localCache” minOccurs=“0”/>
    </xs:all>
  </xs:complexType>
</xs:schema>
```

The following is an example of a layout definition 104:

The following is an example of a chart definition 108:

The following is an example of a prompt definition 110:

The following is an example of a QRD 128:

```
<?xml version=“1.0” encoding=“UTF-8”?>
<!--
  Copyright (C) 2006 Cognos Incorporated. All Rights Reserved.
  Cognos (R) is a trademark of Cognos Incorporated.
-->
<xs:schema  xmlns:xs=“http://www.w3.org/2001/XMLSchema”
    elementFormDefault=“qualified”
    attributeFormDefault=“unqualified”>
    <xs:include schemaLocation=“V5Query.xsd”/>
      <xs:element name=“queryResultDefinition”>
        <xs:annotation>
<xs:documentation>The QRD describes the shape, or
the dimensional structure, of the result set to be returned for
rendering. It will generally be generated from the layout
specification and is used to assist the rendering operation by
delivering the data to be iterated on in the expected form. That
is, the QRD unambiguously specifies a result set structure and
represents a meta-model of the QSAPI. The QRD can be specified
either as one of the available templates or as a set of named edges.
Optional master-detail links, generated from the layout containment
relationships, define the master and detail contexts of the
relationships.</xs:documentation>
      </xs:annotation>
      <xs:complexType>
        <xs:sequence>
          <xs:choice>
            <xs:element name=“edges” minOccurs=“0”>
              <xs:annotation>
                <xs:documentation>a collection
of edges.</xs:documentation>
              </xs:annotation>
              <xs:complexType>
                <xs:sequence>
                  <xs:element name=“edge”
minOccurs=“0” maxOccurs=“unbounded”>
                    <xs:annotation>
      <xs:documentation>a generic edge type that is generated from
the layout information (i.e. the placement of dataItems within a
report  and  their  nesting,  grouping  and
aggregations)</xs:documentation>
                    </xs:annotation>
                    <xs:complexType>
    <xs:complexContent>
    <xs:extension base=“edgeType”>
    <xs:attribute name=“name” type=“xs:string” use=“required”/>
    <xs:attribute  name=“edgeID”  type=“xs:unsignedInt”
use=“optional”/>
    <xs:attribute name=“memberCache” use=“optional”>
    <xs:annotation>
      <xs:documentation>OQP currently caches 100 members along
each edge of a cross tab report and disables this cache when the
“all rows” query hint is enabled. RSVP, when rendering cross tab
reports, re-traverses the column edge for each row of data. If the
number of members along the column edge exceeds the cache size,
performance is impacted. In the case of charts, RSVP re-traverses
both the row and column edge, consequently a large result set as
input to a chart can exhibit even worse performance than a cross
tab.
What is required is a mechanism by which RSVP can control the
caching of members along individual edges of a result set,
independent of the “all rows” query hint. The solution is to
introduce a new, optional attribute to the edge element of the QRD,
called “memberCache”, the purpose of which is to indicate how
members are to be cached along an edge. The three supported values
for the attribute are -default - Members along an edge are cached,
to the maximum specified by the qfs_config.xml file. -none- None of
the members along an edge are cached. -all - All of the members
along an edge are cached. If the attribute does not appear for an
edge, members are cached to the maximum specified in the
qfs_config.xml file and if the “all rows” query hint is disabled. If
the attribute appears on an edge, it overrides the value of the “all
rows” query hint. In addition, the size of the OQP member edge cache
is controlled by the qfs_config.xml property “PPRowCacheSize”, the
default value of which is 1000. The property must be assigned a
value greater than zero, otherwise it defaults to 1000.
</xs:documentation>
    </xs:annotation>
    <xs:simpleType>
      <xs:restriction base=“xs:NMTOKEN”>
        <xs:enumeration value=“default”/>
        <xs:enumeration value=“none”/>
        <xs:enumeration value=“all”/>
      </xs:restriction>
    </xs:simpleType>
    </xs:attribute>
    </xs:extension>
    </xs:complexContent>
                    </xs:complexType>
                  </xs:element>
                </xs:sequence>
              </xs:complexType>
            </xs:element>
          </xs:choice>
          <xs:element  name=“masterDetailLinks”
minOccurs=“0”>
            <xs:annotation>
              <xs:documentation>a collection of MD
links.</xs:documentation>
            </xs:annotation>
            <xs:complexType>
              <xs:sequence>
                <xs:element
name=“masterDetailLink” maxOccurs=“unbounded”>
                  <xs:annotation>
    <xs:documentation>Defines a master-detail relationship. A
master context and a detail context child elements specify the link
filter based on refrenced dataItems or paramters.</xs:documentation>
                  </xs:annotation>
                  <xs:complexType>
                    <xs:all>
                      <xs:element
name=“masterContext”>
    <xs:complexType>
    <xs:sequence>
    <xs:element ref=“dataItemContext”/>
    </xs:sequence>
    <xs:attribute name=“refQueryResultDefinition” type=“xs:string”
use=“required”/>
    </xs:complexType>
                      </xs:element>
                      <xs:element
name=“detailContext”>
    <xs:complexType>
    <xs:choice>
    <xs:element ref=“dataItemContext”/>
    <xs:element ref=“parameterContext”/>
    </xs:choice>
    <xs:attribute name=“refQueryResultDefinition” type=“xs:string”
use=“required”/>
    </xs:complexType>
                      </xs:element>
                    </xs:all>
                  </xs:complexType>
                </xs:element>
            </xs:sequence>
            </xs:complexType>
          </xs:element>
        </xs:sequence>
        <xs:attribute  name=“name”  type=“xs:string”
use=“required”/>
        <xs:attribute  name=“refQuery”  type=“xs:string”
use=“required”/>
      </xs:complexType>
    </xs:element>
    <xs:complexType name=“edgeType”>
      <xs:annotation>
        <xs:documentation>a canonical edge specification
that defines a list or a xtab/chart edge</xs:documentation>
      </xs:annotation>
      <xs:all>
        <xs:element ref=“edgeGroups” minOccurs=“0”/>
      </xs:all>
    </xs:complexType>
    <xs:complexType name=“edgeGroupType”>
      <xs:annotation>
        <xs:documentation>an arbitrary shaped set of values
on an edge</xs:documentation>
      </xs:annotation>
      <xs:all>
        <xs:element name=“valueSets”>
          <xs:annotation>
            <xs:documentation>unions of value sets,
each refrences a dataItem and defines a group body, header, and/or
footer </xs:documentation>
          </xs:annotation>
          <xs:complexType>
            <xs:sequence>
              <xs:element  name=“valueSet”
maxOccurs=“unbounded”>
                <xs:annotation>
                  <xs:documentation>a
valueSet, also known as a memberSet, defines a collection of values
or members to be returned for this edgeGroup. It represents a
(nesting) level in an explorer style edge. The refDataItem
attribute of this element represents the “key” associated with the
level. Level properties can be specified in the groupBody child
element as a list of dataItemRefs. Seven default memeber properties
can be specified as property expression.</xs:documentation>
                </xs:annotation>
                <xs:complexType>
                  <xs:complexContent>
                    <xs:extension
base=“valueSetType”/>
                  </xs:complexContent>
                </xs:complexType>
              </xs:element>
            </xs:sequence>
          </xs:complexType>
        </xs:element>
        <xs:element ref=“edgeGroups” minOccurs=“0”/>
      </xs:all>
    </xs:complexType>
    <xs:complexType name=“overallHeaderType”>
      <xs:annotation>
        <xs:documentation>a  list  overall
header</xs:documentation>
      </xs:annotation>
      <xs:sequence>
        <xs:element  ref=“dataItemRef”
maxOccurs=“unbounded”/>
      </xs:sequence>
    </xs:complexType>
    <xs:complexType name=“overallFooterType”>
      <xs:annotation>
        <xs:documentation>a  list  overall
footer</xs:documentation>
      </xs:annotation>
      <xs:sequence>
        <xs:element  ref=“dataItemRef”
maxOccurs=“unbounded”/>
      </xs:sequence>
    </xs:complexType>
    <xs:complexType name=“groupSortType”>
      <xs:annotation>
        <xs:documentation>specifies how members of the group
are sorted</xs:documentation>
      </xs:annotation>
      <xs:sequence>
        <xs:element ref=“sortItem” maxOccurs=“unbounded”/>
      </xs:sequence>
    </xs:complexType>
    <xs:element name=“edgeGroup”>
      <xs:annotation>
        <xs:documentation>a node in a tree of member
sets</xs:documentation>
      </xs:annotation>
      <xs:complexType>
        <xs:complexContent>
          <xs:extension base=“edgeGroupType”>
            <xs:attribute  name=“name”
type=“xs:string” use=“optional”/>
          </xs:extension>
        </xs:complexContent>
      </xs:complexType>
    </xs:element>
    <xs:element name=“details”>
      <xs:annotation>
        <xs:documentation>a  list  report  detail
column.</xs:documentation>
      </xs:annotation>
      <xs:complexType>
        <xs:sequence>
          <xs:element  ref=“dataItemRef”
maxOccurs=“unbounded”/>
        </xs:sequence>
      </xs:complexType>
    </xs:element>
    <xs:element name=“dataItemRef”>
      <xs:annotation>
        <xs:documentation>a reference to a selection
dataItem. In a context that requires many dataItemRefs (a group
footer for example), each dataItemRef must be
unique.</xs:documentation>
      </xs:annotation>
      <xs:complexType>
          <xs:attribute name=“refDataItem” type=“xs:string”
use=“required”/>
      </xs:complexType>
    </xs:element>
    <xs:element name=“dataItemContext”>
      <xs:annotation>
        <xs:documentation>for linking master/detail queries
</xs:documentation>
      </xs:annotation>
      <xs:complexType>
        <xs:attribute name=“refDataItem” type=“xs:string”
use=“required”/>
      </xs:complexType>
    </xs:element>
    <xs:element name=“parameterContext”>
      <xs:annotation>
        <xs:documentation>for  linking  master/detail
      queries</xs:documentation>
      </xs:annotation>
        <xs:complexType>
<xs:attribute name=“parameter” type=“xs:string”
      use=“required”/>
    </xs:complexType>
    </xs:element>
      <xs:element name=“edgeGroups”>
        <xs:annotation>
<xs:documentation>represents an arbitrary shaped set
of members (data values) on an edge. A flat list of non-nested edge
groups in an edge specification can be used to represent the
unioning of member sets. Each group in the list can have one or
more valueSets that represent the group's members (based on a
caption key and associated body attributes), an optionial header
and/or footer, a sort, and a supression. An explorer-mode crosstab
edge can be specified by a set of nested edge groups. A reporter-
mode crosstab edge can be specified by nesting and unioning edge
groups. A grouped list report can be specified by a set of nested
edge groups with the inner most edge group representing the details.
This special group is not keyed on anly level (i.e. it valueSet has
not refDataItem attribute) and its body references the detail
columns as level attributes. </xs:documentation>
      </xs:annotation>
      <xs:complexType>
        <xs:sequence>
          <xs:element  ref=“edgeGroup”
maxOccurs=“unbounded”/>
        </xs:sequence>
      </xs:complexType>
    </xs:element>
    <xs:element name=“layers”>
      <xs:annotation>
        <xs:documentation>a data section in a cross tab or a
chart template</xs:documentation>
      </xs:annotation>
      <xs:complexType>
        <xs:sequence maxOccurs=“unbounded”>
          <xs:element name=“layerEdge”>
            <xs:complexType>
              <xs:sequence>
                <xs:element ref=“dataItemRef”
maxOccurs=“unbounded”/>
              </xs:sequence>
          </xs:complexType>
          </xs:element>
        </xs:sequence>
      </xs:complexType>
    </xs:element>
    <xs:element name=“cells”>
      <xs:annotation>
        <xs:documentation> cross tab  fact
values</xs:documentation>
      </xs:annotation>
      <xs:complexType>
        <xs:sequence maxOccurs=“unbounded”>
          <xs:element ref=“dataItemRef”/>
        </xs:sequence>
      </xs:complexType>
    </xs:element>
    <xs:element name=“overallHeader” type=“overallHeaderType”>
      <xs:annotation>
        <xs:documentation>a  list  report  overall
header.</xs:documentation>
      </xs:annotation>
    </xs:element>
    <xs:element name=“overallFooter” type=“overallFooterType”>
      <xs:annotation>
        <xs:documentation>a  list  report  overall
footer.</xs:documentation>
      </xs:annotation>
    </xs:element>
    <xs:element name=“groupHeader”>
      <xs:annotation>
        <xs:documentation>defines a member that represents a
summary of the group members. Logically returned before the group
members </xs:documentation>
      </xs:annotation>
      <xs:complexType>
        <xs:sequence>
          <xs:element ref=“dataItemRef” minOccurs=“0”
maxOccurs=“unbounded”/>
        </xs:sequence>
        <xs:attribute name=“ name”  type=“xs:string”
      use=“required”/>
    </xs:complexType>
    </xs:element>
      <xs:element name=“groupFooter”>
        <xs:annotation>
<xs:documentation>defines a member that reoresents a
summary of the group members. Logically returned after the group
      members</xs:documentation>
      </xs:annotation>
        <xs:complexType>
          <xs:sequence>
<xs:element ref=“dataItemRef” minOccurs=“0”
        maxOccurs=“unbounded”/>
          </xs:sequence>
<xs:attribute name=“ name”  type=“xs:string”
        use=“required”/>
        </xs:complexType>
    </xs:element>
    <xs:element name=“groupSort” type=“groupSortType”>
      <xs:annotation>
        <xs:documentation>The groupSort child element of the
valueSet element defines the sort order for the group members within
a context defined by the entire result set. A query author can
define a sort using projected and non projected items as was the
case in Baltic. The groupSort can reference a data item form the
associated query even if the data item was not used in QRD. For a
detail group (i.e. a group with a valueSet that has no data item
reference and has a group body reference a list of items) the order
the groupSort items dictates the order in which the details are
sorted.</xs:documentation>
      </xs:annotation>
    </xs:element>
    <xs:element name=“propertyExpressions”>
      <xs:complexType>
        <xs:sequence>
          <xs:element  name=“propertyExpression”
type=“xs:string” minOccurs=“0” maxOccurs=“unbounded”>
            <xs:annotation>
    <xs:documentation>RoleValue(‘_memberUniqueName’),
RoleValue(‘_memberCaption’),  RoleValue(‘_levelUniqueName’),
RoleValue(‘_levelNumber’),  RoleValue(‘_levelLabe’)l,
RoleValue(‘_parentUniqueName’),
RoleValue(‘_dimensionUniqueName’),
RoleValue(‘_hierarchyUniqueName’),
RoleValue(‘_queryItemModelID’)
</xs:documentation>
            </xs:annotation>
          </xs:element>
        </xs:sequence>
      </xs:complexType>
    </xs:element>
    <xs:complexType name=“valueSetType”>
      <xs:all>
        <xs:element ref=“groupHeader” minOccurs=“0”/>
        <xs:element name=“groupBody” minOccurs=“0”>
          <xs:annotation>
            <xs:documentation>defines the attributes
to be returned for each member in the group.</xs:documentation>
          </xs:annotation>
          <xs:complexType>
            <xs:sequence>
              <xs:element  ref=“dataItemRef”
minOccurs=“0” maxOccurs=“unbounded”/>
              <xs:element
ref=“propertyExpressions” minOccurs=“0”/>
            </xs:sequence>
            <xs:attribute  name=“name”
type=“xs:string” use=“optional”/>
          </xs:complexType>
        </xs:element>
        <xs:element ref=“groupFooter” minOccurs=“0”/>
        <xs:element ref=“groupSort” minOccurs=“0”/>
        <xs:element  ref=“propertyExpressions”
minOccurs=“0”/>
      </xs:all>
      <xs:attribute  name=“name”  type=“xs:string”
use=“required”/>
      <xs:attribute  name=“refDataItem”  type=“xs:string”
use=“optional”/>
<xs:attribute  name=“solveOrder”  type=“xs:integer”
default=“0”>
      <xs:annotation>
        <xs:documentation>Specifies the solve order
for this calculation. If no solve order is specified then the solve
order will be follow the default rules that the server uses to
determine solve order.</xs:documentation>
        </xs:annotation>
      </xs:attribute>
    </xs:complexType>
</xs:schema>
```

The following are examples of other definitions referred to by the definitions set out above:

The system and methods of the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal and its carrier are also within the scope of the present invention, as well as the hardware, software and the combination thereof.

The present invention has been described with regard to one or more embodiments. However, it will be apparent to persons skilled in the art that a number of variations and modifications can be made without departing from the scope of the invention as defined in the claims.

What is claimed is:

1. A report model for defining a report, the report model comprising:
a query data specification for defining one or more sets of data that are to be reported against; and
a layout specification for defining how the data is to be structured and rendered, the layout specification including elements that are typically defined in a query.

2. The report model as claimed in claim 1, further comprising:
a burst specification for defining how the report is to be segmented and delivered to various recipients.

3. The report model as claimed in claim 1, wherein the layout specification includes:
a chart specification for defining how the data is to be structure and rendered in a chart form; and
a prompt specification for defining how to prompt for parameters that can be used in the definition of the query.

4. The report model as claimed in claim 1, wherein the data selection specification references an underlying metadata model which can be relational or multidimensional.

5. A method of producing a report output from a report definition, the method comprising the steps of:
decomposing a report definition into a layout definition and a query set component;
processing a query results definition of the query set to produce query results to be rendered; and
creating the final report by using the query results and the layout definition.

6. The method as claimed in claim 5, further comprising the step of extracting a topology of a data selection from the layout definition into a query results definition for defining how the data should be structured for rendering, the data selection and query results definition forming part of the query set.

7. The method as claimed in claim 5, further comprising the step of receiving the report definition.

8. A system of producing a report output form a report definition, the system comprising:
a report engine for decomposing a report definition into a layout definition and a query set component;
a query engine for processing a query results definition of the query set to produce query results to be rendered;
a rendering engine for creating the final report by using the query results and the layout definition.

9. The method as claimed in claim 8, wherein the query set comprises a data selection and a query results definition for defining how the data should be structured for rendering.

10. A memory containing computer executable instructions that can be read and executed by a computer for caring out a method of producing a report output from a report definition, the method comprising the steps of:
decomposing a report definition into a layout definition and a query set component;
processing a query results definition of the query set to produce query results to be rendered; and
creating the final report by using the query results and the layout definition.

11. A carrier carrying a propagated signal containing computer executable instructions that can be read and executed by a computer, the computer executable instructions being used to execute a method of producing a report output from a report definition, the method comprising the steps of:
decomposing a report definition into a layout definition and a query set component;
processing a query results definition of the query set to produce query results to be rendered; and
creating the final report by using the query results and the layout definition.
